(19) United States
(12) Patent Application Publication
(10) Pub. No.: US 2024/0428189 A1
(43) Pub. Date: Dec. 26, 2024

(54) PHARMACEUTICAL ASSET TRACKING

(71) Applicant: Genentech, Inc., South San Francisco, CA (US)

(72) Inventors: Richard William Alas, Novato, CA (US); Paul Gregoire Deroulhac, San Francisco, CA (US)

(21) Appl. No.: 18/828,915

(22) Filed: Sep. 9, 2024

Related U.S. Application Data
(63) Continuation of application No. PCT/US2023/064066, filed on Mar. 9, 2023.
(60) Provisional application No. 63/318,618, filed on Mar. 10, 2022.

(51) Int. Cl. G06Q 10/087

(52) U.S. Cl. CPC G06Q 10/087

(57) ABSTRACT

Pharmaceutical asset tracking systems and methods for pharmaceutical asset tracking are disclosed. The system comprises a pharmaceutical asset tracker to transmit pharmaceutical asset information to a communications device. The pharmaceutical asset information comprises an identifier for a pharmaceutical asset associated with the pharmaceutical asset tracker in a defined area. The communications device is responsive to communications via a crowdsourcing protocol, and the pharmaceutical asset tracker transmits the pharmaceutical asset information to the communications device via the responsive crowdsourcing protocol. The system comprises a server configured to receive the pharmaceutical asset information and location information from the communications device. The server may determine, based on the location information, a location of the asset, and provide for display information regarding a group of pharmaceutical assets determined to be at a specified location. The group is identified based on pharmaceutical asset information for each of the assets in the group.

### CROSS-REFERENCE TO RELATED APPLICATION

This application is a continuation of International Application No. PCT/US2023/064066, filed on Mar. 9, 2023, which claims priority to and the benefit of U.S. Provisional Application No. 63/318,618 filed Mar. 10, 2022, the entire content of which is incorporated herein by reference in its entirety.

### TECHNICAL FIELD

This disclosure generally relates to systems for tracking pharmaceutical assets.

### BACKGROUND

In order to ensure that a prescription for high demand medication is guaranteed to be filled by a pharmacy, it is necessary to know the real-time inventory levels across 40,000+ individual pharmacies at the time a prescription is written. This information must not only be known but also must be accessible to critical stakeholders in the process including physicians and patients. Pharmacies have different systems and processes for inventory management that extend across a continuum from highly manual to automated Few, if any, local inventory systems are capable of providing “real-time” visibility. In summary there is no practical or economical method today to capture sufficient inventory visibility to guarantee that medicine will be available when a patient arrives at a pharmacy. This challenge is especially acute with time-critical medications.

The process of taking a count of drugs at a specific pharmacy location is traditionally handled by the retailer either (1) counting stock on hand of all drugs on a periodic basis (e.g., on an annual, semi-annual, or quarterly basis), (2) counting stock on hand of specific, seasonal products on a seasonal basis (e.g., seasonal drugs, such as allergy or flu medicine), or (3) using business or accounting software to track sales, returns, and reconciliations (to account for product spoilage/expiration, theft, misplaced assets, or obsolescence), which typically requires periodic (e.g., weekly or monthly) cycle counts to help reconcile information tracked by the software with actual physical inventory on hand. By necessity, such drug information is typically generated by a pharmacy and only visible to the pharmacy. However, the supplier who is responsible for meeting demand and keeping shelves well-stocked (e.g., a pharmaceutical supplier, a wholesale distributor, manufacturer, broker, or agent) may not have access to that drug information and may be unable to proactively respond rapidly when needed. A physician may also not have access to this drug information, which may be helpful while writing a prescription for a patient, to direct the patient to a pharmacy with sufficient stock.

During an outbreak of a disease, such as an epidemic, pandemic, or a seasonal outbreak, the demand for medication for the disease may fluctuate significantly across geographic regions, leading to high volatility and unpredictability of demand between different retail pharmacy locations (e.g., drug stores, grocery stores, clinics, hospitals, or schools). During such an outbreak, there may be a severe imbalance between supply and demand even between nearby pharmacies in the region that may lead to lost sales, wasted inventory, and ultimately, unnecessary increases in the duration and severity of the outbreak. The inability for a supplier to track levels of inventory of medication available at brick-and-mortar retail locations in real time may lead to a lack of visibility into which retail locations have insufficient supply to meet demand and which retail locations have aging inventory that is getting close to its expiration date and must be discarded, inventory that has been compromised in terms of its storage conditions, etc. In addition, unlike other types of retail products, the inability for one person to purchase medication quickly and as needed may not only result in consumer frustration, but may actually increase the gap between supply and demand if the disease is contagious and spreads to more people.

This problem is magnified when the supplier is providing a given product across more than one retailer (e.g., two different chains of drug stores, or a chain of drug stores and a chain of hospitals), since implementing a common process across the retailers may be challenging and cost-prohibitive.

### SUMMARY

The systems and methods disclosed herein may advantageously allow visibility to pharmaceutical asset information across different locations in an autonomous manner that minimally affects a business. Furthermore, these systems and methods, which neither rely on traditional counting nor software tracking, may facilitate complete control or a high level of control of tracking pharmaceutical assets by a supplier, a physician, or a patient, without relying on information provided by or software or hardware installed by the pharmacy.

Systems and methods for pharmaceutical asset tracking are disclosed. In some embodiments, the system comprises a pharmaceutical asset tracker configured to transmit pharmaceutical asset information to a communications device (e.g., a mobile phone). The pharmaceutical asset information comprises an identifier for a pharmaceutical asset (e.g., a packet of medicine) associated with the pharmaceutical asset tracker in a defined area (e.g., a pharmacy). The pharmaceutical asset tracker transmits the pharmaceutical asset information to the communications device via a crowdsourcing protocol used to transmit the pharmaceutical asset information to the communications device.

In some embodiments, the system comprises a pharmaceutical asset tracker configured to transmit pharmaceutical asset information to a communications device (e.g., a mobile phone). The pharmaceutical asset information comprises an identifier for a pharmaceutical asset (e.g., a packet of medicine) associated with the pharmaceutical asset tracker in a defined area (e.g., a pharmacy). In accordance with the communications device being responsive to communications via a crowdsourcing protocol (e.g., a first crowdsourcing protocol or a second crowdsourcing protocol), the pharmaceutical asset tracker transmits the pharmaceutical asset information to the communications device via the crowdsourcing protocol used to transmit the pharmaceutical asset information to the communications device.

In some embodiments, the pharmaceutical asset tracker may transmit the pharmaceutical asset information to the communications device in response to receiving a request originated by a server for the pharmaceutical asset information. The server may determine, based on the location information, a location of the asset, and provide for display information regarding a group of pharmaceutical assets determined to be at a specified location. The group is identified based on pharmaceutical asset information for each of the assets in the group.

The embodiments disclosed above are only examples, and the scope of this disclosure is not limited to them. Particular embodiments may include all, some, or none of the components, elements, features, functions, operations, or steps of the embodiments disclosed above. Embodiments according to the invention are in particular disclosed in the attached claims directed to a method, a storage medium, a system and a computer program product, wherein any feature mentioned in one claim category, e.g., method, can be claimed in another claim category, e.g., system, as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1 illustrates an overview of an example pharmaceutical asset tracking system.

FIG. 2 illustrates an example method for pharmaceutical asset tracking.

FIG. 3 illustrates an example electronic system.

### DESCRIPTION OF EXAMPLE EMBODIMENTS

In some embodiments, the disclosed systems comprise a pharmaceutical asset tracker that is configured to transmit information about an associated pharmaceutical asset, via one or more crowdsourcing protocols, to a server by way of one or more third-party responsive communications devices. In some embodiments, the one or more third-party responsive communications devices may comprise a peer-to-peer network.

In some embodiments, a crowdsourcing protocol is a communications protocol for obtaining information (e.g., via an application associated with the crowdsourcing protocol, via an operating system associated with the crowdsourcing protocol (e.g., integrated with the operating system, no additional installation of application is necessary)) by enlisting services of a plurality of user devices. A crowdsourcing protocol establishes how communications are transmitted between the pharmaceutical asset tracker and the communications devices (e.g., the PYTHON PYTILE API, which is used to retrieve information on TILE Bluetooth trackers, or the NEARBY INTERACTION framework, which is used to retrieve information on APPLE AIRTAGS, or the Devices API for the SAMSUNG SMARTTHINGS platform, which is used to retrieve information on SAMSUNG GALAXY SMARTTAGS). Upon receiving the transmitted information from the pharmaceutical asset tracker, the communications device transmits the information (e.g., to a server, to another communications device, within the communications device) for further processing (e.g., locating the asset, monitoring the asset, inventory monitoring). The disclosed systems and methods may advantageously allow visibility to inventory levels across different locations in an autonomous manner that minimally affects a business. That is, by leveraging the one or more crowdsourcing protocols and using the communications devices (e.g., devices that may not belong to an employee of the business, devices not intended for tracking inventory), the business may not need additional resources for monitoring pharmaceutical assets and/or different kinds of assets, allowing plug-and-play capability for the different assets. Using these systems and methods, traditional counting or on-site systems that record inventory may not be needed for tracking inventory.

As additional examples, by communicating the pharmaceutical asset information as disclosed, displaying of drug availability at different locations to physicians and patients, price arbitrage, counterfeit detection, theft detection, transferring of drugs to other countries, parallel trade, and tampering protection may be achieved without needing additional resources from a stakeholder.

Embodiments disclosed herein capture the data that enables visibility into inventory positions across a broad and diffuse distribution of pharmacy locations in a way that is seamless and efficient. This is achieved by using a Bluetooth-based crowd-sourcing protocol, thereby eliminating the need for costly and invasive network infrastructure to be installed in order to capture the necessary data.

Embodiments disclosed herein allow capture of inventory data over a consumer crowd source network using an individual's smart phone, smart tablet, or other Bluetooth-enabled device as a data transport mechanism. Embodiments disclosed herein use a consumer-enabled crowdsource network and enable inventory visibility by tagging each unit of inventory with a unique device that is recognizable by the crowdsource network. The inventory is thereby made “discoverable” by the crowdsource network of consumer devices. The instance of “discovery” is then communicated to a user delivering a view of the inventory position within a given pharmacy location.

Embodiments disclosed herein enable many different potential use case applications that may be otherwise more costly. In some embodiments, the disclosed systems and methods allow, for example:
Communicating inventory availability in a real-time manner to a prescribing physician during a flu epidemic to ensure prescriptions are written to a pharmacy with available inventory;
Communicating inventory availability to a patient's Health App. on their phone so that they can self-select a preferred pharmacy;
Connecting an enabled product to a patient phone App allowing direct patient communication;
   This capability would facilitate questions a patient may have around dosage, medical progress, and other topics of concern.
Sharing collected data with pharmacies to enable re-balancing of inventory across pharmacy locations;
Visibility to sectors of the country where there is high demand, allowing distributors to ensure additional inventory is available and to direct assets to where it is needed most;
Real-time consumption data, which enables improved forecasting, optimizing inventory, and reducing cost to society; and
Fraud detection and prevention and mitigation of misdirected product.

The applications or use cases enabled by embodiments disclosed herein touch all aspects of the lifecycle, such as:
Physician
Patient
Retail
Distribution
Demand Forecasting and Manufacturing

In addition to the above-mentioned scenarios, there may be additional use cases for embodiments disclosed:
Parallel Trade: due to the nature of the pharmaceutical industry, costs for products differ across countries and regions. There is a known challenge where product is purchased from low cost countries and is re-sold in higher cost countries. This is known as parallel trade. Visibility to inventory throughout its transportation cycle may enable identification and mitigation of parallel trade.
Government Discount Programs: certain products are designated for underserved populations and sold at a discount. In order for the program to be effective, products may need to be administered in designated locations that support the program. If products are misdirected it will be sold at the full price and will not reach the desired population. Visibility at the unit level may enable identification of product that has been misdirected, mitigate the occurrence and improve patient access.
Improved Demand Sensing: This real-time platform provides visibility into the ultimate destination of products and will enable improved demand forecasting partnership with commercial entities to smooth supply reducing waste and overall cost to society. This will also enable identification of shortages in real-time and fulfill the market more effectively.
Excursion Management: many products are designed to be handled between 2°-8° Celsius. Embodiments disclosed herein may enable monitoring products within the cold chain and during handling within a hospital network. Embodiments disclosed herein may enable monitoring the stability budget (how much time a product can be outside of refrigeration) and identifying product that has exceeded its stability budget, thereby improving patient safety and product efficacy.
Anti-Counterfeit: the visibility of the location of the product throughout its lifecycle will enable identification of product that is sent to a place other than a known location thereby reducing the potential for counterfeit and misdirected products.
Patient Engagement: embodiments disclosed herein may be connected to a community with a phone-based app. This would enable direct communication between a manufacturer and the patient through the app.
Inventory management within the Healthcare Partners/Healthcare Providers (HCP) community: embodiments disclosed herein provide visibility to inventory count and location within a hospital campus, which may be valuable to associated stakeholders.
Dispense information: embodiments disclosed herein may enable visibility to the point of dispense to a patient, which may be more challenging without using the disclosed systems and methods. The visibility to the point of dispense provides a manufacturer visibility to true demand and enables deferred invoicing, which can benefit smaller clinics. For example, a distributor may be invoiced on dispense, compared to receipt of product.
Expiration: embodiments disclosed herein may provide visibility of products approaching expiration date to HCPs. This would enable action to be taken to ensure units approaching expiration date are dispensed to a patient at the next opportunity, which would decrease waste and decrease loss of product.
Visibility to true downstream demand: embodiments disclosed herein may provide visibility to receipt and dispense within HCPs, which can be beneficial to distributors in terms of allocation and order management.
Auto reordering: embodiments disclosed herein may allow collaboration between distributors and HCPs to enable auto reorder when inventory reaches below a defined threshold.

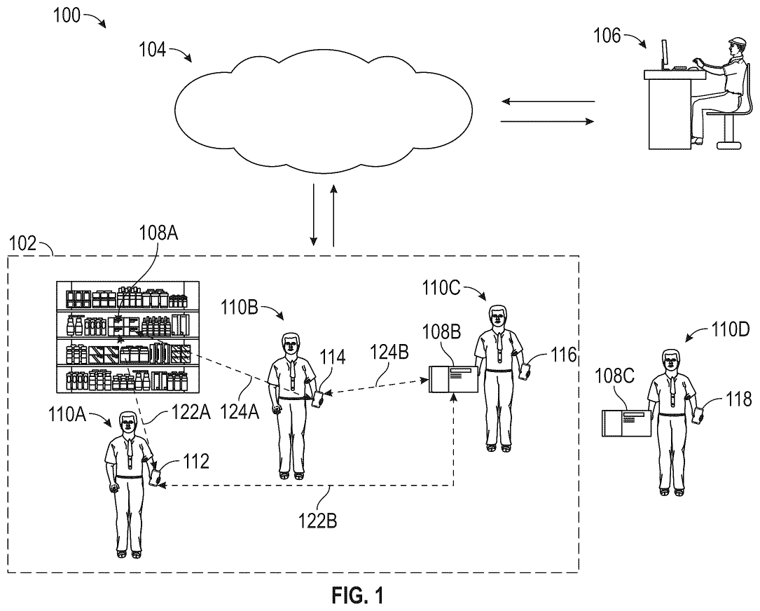

FIG. 1 illustrates an overview of an example pharmaceutical asset tracking system 100. In some embodiments, the system 100 comprises a pharmaceutical asset tracker (e.g., pharmaceutical asset trackers 108A, 108B, 108C). For example, the pharmaceutical asset tracker is a tracker for locating a pharmaceutical asset, and the pharmaceutical asset tracker is configured to transmit data via a crowdsourcing protocol (e.g., a crowdsourcing protocol associated with TILE trackers, a crowdsourcing protocol associated with the APPLE AIRTAGS).

In particular embodiments, the pharmaceutical asset tracker is configured to transmit pharmaceutical asset information to a communications device (e.g., communications devices 112, 114, 116, and 118). In some embodiments, the communications device comprises electronic system 300. In some embodiments, the communications device is a mobile phone, and the mobile phone is associated with a user. For example, communications device 112 is associated with user 110A, communications device 114 is associated with user 110B, communications device 116 is associated with user 110C, and communications device 118 is associated with user 110D.

In some embodiments, the pharmaceutical asset tracker is configured to transmit the pharmaceutical asset information via Bluetooth Low Energy (BLE). For example, the pharmaceutical asset tracker is a tracker for locating a pharmaceutical asset, and the pharmaceutical asset tracker is configured to transmit data via one or more crowdsourcing protocols using BLE. The tracker is configured transmit the pharmaceutical asset information to a communications device via BLE, advantageously allowing the pharmaceutical asset tracker to operate in low power.

In some embodiments, the pharmaceutical asset tracker is configured to transmit the pharmaceutical asset information via ultra-wideband (UWB) (e.g., a band between 3-10.6 GHz). Spatial and directional data provided by UWB may be used to locate the pharmaceutical asset tracker and a pharmaceutical asset associated with the pharmaceutical asset tracker, as described in more detail herein. Although BLE and UWB are described as exemplary communications methods for transmitting pharmaceutical asset information from the pharmaceutical asset tracker, it is understood that other wireless or wired communications methods may be used to transmit the pharmaceutical asset information from the pharmaceutical asset tracker.

In particular embodiments, the pharmaceutical asset information comprises an identifier for a pharmaceutical asset associate with the pharmaceutical asset tracker in a defined area. For example, the pharmaceutical asset information comprises an identifier for a packet of medicine in a pharmacy. In some embodiments, the defined area has an area less than a transmission range of the pharmaceutical asset tracker.

In some embodiments, the identifier uniquely identifies the asset. For example, the identifier comprises a code for uniquely identifying the packet of medicine (e.g., for individually tracking each packet of medicine). In some embodiments, the pharmaceutical asset tracker may prevent counterfeiting of the asset. For example, the identifier is configured for verifying authenticity of the asset. The identify may comprise information for verifying authenticity of the asset to prevent counterfeiting of the asset. As another example, the presence of a pharmaceutical asset tracker with the asset may confirm the authenticity of the asset.

In some embodiments, the asset comprises the pharmaceutical asset tracker. For example, the pharmaceutical asset tracker is integrated with the asset. As a specific example, the pharmaceutical asset tracker is part of a packaging of the asset (e.g., a packet of medicine). In some embodiments, the pharmaceutical asset tracker is attached to the asset. For example, the pharmaceutical asset tracker is attached (e.g., using an adhesive) to a packaging of the asset (e.g., a packet of medicine). In particular embodiments, the asset is portable. For example, the asset (e.g., a packet of medicine) may be picked up by a customer or an employee and transported to a different location (e.g., user 110C may pick up asset associated with pharmaceutical asset tracker 108B). In some embodiments, the pharmaceutical asset tracker has a thickness of less than 1.5 mm. In some embodiments, the pharmaceutical asset tracker comprises a sensor configured to detect UV light. The sensor advantageously enables determination of whether the associated asset has been exposed to UV light contamination. In some embodiments, the pharmaceutical asset tracker comprises a sensor configured to detect temperature of an environment of the asset. The sensor may be used to determine temperature excursion. For example, an asset may be designed to be handled between 2°-8° Celsius. The sensor may be used to determine whether the asset has been exposed to temperature outside of this range. Information obtained by a sensor of the pharmaceutical asset tracker may be transmitted via methods described herein.

In some embodiments, the pharmaceutical asset tracker comprises software (e.g., firmware associated with a compatible crowdsourcing protocol) that allows the pharmaceutical asset tracker to transmit data via the one or more crowdsourcing protocols. In some embodiments, the software of the pharmaceutical asset tracker is updatable, such that the pharmaceutical asset tracker may be updated to transmit data via additional or different crowdsourcing protocols. In some embodiments, the pharmaceutical asset tracker comprises a battery (e.g., lithium battery). In some embodiments, the battery is configured to power the pharmaceutical asset tracker for the duration of the lifetime of an associated asset (e.g., the battery can power the pharmaceutical asset tracker until the expiration date of the associated asset).

In some embodiments, the pharmaceutical asset information comprises is associated with product information of the asset. For example, the product information comprises one or more of manufacturer information, product name, product type, date of manufacture, batch ID, quality inspection-related information, expiration date, serial number, lot ID, NDC number, category information, type information, dosage type (e.g., infant, adult), and storage requirement (e.g., cold storage, room temperature storage). In some embodiments, a server (e.g., server 104, which may comprise a cloud computing device) is configured to store the product information, and the server is configured to retrieve the product information based on the received pharmaceutical asset information. By storing the product information at the server, sensitive information about the product may not be transmitted and potentially be intercepted from a pharmaceutical asset tracker to a communications device.

In some embodiments, the pharmaceutical asset tracker transmits the pharmaceutical asset information to a communications device via a crowdsourcing protocol (e.g., one of the crowdsourcing protocols disclosed herein). For example, the pharmaceutical asset tracker (e.g., pharmaceutical asset tracker 108A, pharmaceutical asset tracker 108B) transmits the pharmaceutical asset information via a first crowdsourcing protocol (e.g., crowdsourcing protocol 122A). A communications device (e.g., communications device 112) responsive to communications via the first crowdsourcing protocol (e.g., the communications device comprises a tracking application associated with the first crowdsourcing protocol) would receive the pharmaceutical asset information from the pharmaceutical asset tracker. As another example, the pharmaceutical asset tracker (e.g., pharmaceutical asset tracker 108A, pharmaceutical asset tracker 108B) transmits the pharmaceutical asset information via a second crowdsourcing protocol (e.g., crowdsourcing protocol 122B). A communications device (e.g., communications device 112) responsive to communications via the second crowdsourcing protocol (e.g., the communications device comprises a tracking application associated with the second crowdsourcing protocol) would receive the pharmaceutical asset information from the pharmaceutical asset tracker.

In some embodiments, in accordance with the communications device being responsive to communications via a first crowdsourcing protocol, the pharmaceutical asset tracker transmits the pharmaceutical asset information to the communications device via the first crowdsourcing protocol. In accordance with the communications device being responsive to communications via a second crowdsourcing protocol, the pharmaceutical asset tracker transmits the pharmaceutical asset information to the communications device via the second crowdsourcing protocol.

For example, a communications device (e.g., communications device 112) is responsive to communications via a first crowdsourcing protocol. In accordance with the communications device being responsive to communications via the first crowdsourcing protocol (e.g., the communications device comprises a tracking application associated with the first crowdsourcing protocol), the pharmaceutical asset tracker (e.g., pharmaceutical asset tracker 108A, pharmaceutical asset tracker 108B) transmits the pharmaceutical asset information to the communications device via the first crowdsourcing protocol (e.g., crowdsourcing protocol 122A, crowdsourcing protocol 122B). In accordance with the communications device (e.g., communications device 114, communications device 116) not being responsive to communications via the first crowdsourcing protocol (e.g., the communications device does not comprise a tracking application associated with the first crowdsourcing protocol), the pharmaceutical asset tracker forgoes transmitting the pharmaceutical asset information to the communications device via the first crowdsourcing protocol.

As another example, a communications device (e.g., communications device 114) is responsive to communications via a second crowdsourcing protocol. In accordance with the communications device being responsive to communications via the second crowdsourcing protocol (e.g., the communications device comprises a tracking application associated with the second crowdsourcing protocol), the pharmaceutical asset tracker (e.g., pharmaceutical asset tracker 108A, pharmaceutical asset tracker 108B) transmits the pharmaceutical asset information to the communications device via the second crowdsourcing protocol (e.g., crowdsourcing protocol 124A, crowdsourcing protocol 124B). In accordance with the communications device (e.g., communications device 112, communications device 116) not being responsive to communications via the second crowdsourcing protocol (e.g., the communications device does not comprise a tracking application associated with the second crowdsourcing protocol), the pharmaceutical asset tracker forgoes transmitting the pharmaceutical asset information to the communications device via the second crowdsourcing protocol. For example, because the communications device 116 is neither responsive to the first nor the second crowdsourcing protocol, the pharmaceutical asset tracker does not transmit the pharmaceutical asset information to the communications device 116.

In some embodiments, the communication between the pharmaceutical asset tracker and the communications device is secure. In some examples, a user of the communications device cannot access the pharmaceutical asset information because the communications device mere serves as a relay for transmitting the pharmaceutical asset information to the server; the user does not have access to sensitive information related to the asset.

In some embodiments, the system 100 further comprises a server (e.g., server 104). In some embodiments, the server comprises the electronic system 300. In particular embodiments, the server is configured to receive the pharmaceutical asset information and location information from the communications device. For example, after the communications device receives the pharmaceutical asset information from the pharmaceutical asset tracker via a responsive crowdsourcing protocol (e.g., the communications protocol used to transmit the pharmaceutical asset information to the communications device), the communications device transmits the pharmaceutical asset information to the server for further processing, as disclosed herein. For example, communications devices 112 and 114 transmit pharmaceutical asset information and location information to server 104.

In some embodiments, the communications device may be further configured to transmit location information to the server. Examples of the determination of the location information are disclosed herein (e.g., based on a responsive crowdsourcing protocol, based on UWB transmission).

It is understood that the server may receive the pharmaceutical asset information and location information from the communications device directly or indirectly. For example, the communications device may communicate the pharmaceutical asset information and location information with one or more intermediate devices (e.g., a networking device, another communications device, another server), and the one or more intermediate devices transmit the pharmaceutical asset information and the location information to the server.

In some embodiments, the location information is determined based on the crowdsourcing protocol used to transmit the pharmaceutical asset information to the communications device. For example, the pharmaceutical asset tracker is a tracker for locating a pharmaceutical asset, and the pharmaceutical asset tracker is configured to transmit data via one or more crowdsourcing protocols. Based on the crowdsourcing protocol used for transmission, a direction and/or distance of the pharmaceutical asset tracker (e.g., and the asset the pharmaceutical asset tracker is attached to) relative to the communications device receiving the pharmaceutical asset information may be determined (e.g., using an application associated the crowdsourcing protocol used for transmission).

In some embodiments, the location information is based on the transmission of the pharmaceutical asset information via UWB. For example, spatial and directional data provided by UWB may be used to locate the pharmaceutical asset tracker and a pharmaceutical asset associated with the pharmaceutical asset tracker. In some embodiments, the location information further comprises GPS coordinates.

In some embodiments, the location information is used to direct a user of the communications device to the asset. For example, after the location information is determined based on the crowdsourcing protocol used to transmit the pharmaceutical asset information or via UWB, the communications device may generate a notification for directing the user to the asset based on the location information. As a specific example, after the location information of pharmaceutical asset tracker 108A is determined by communications device 112 via communications protocol 122A or UWB, the communications device 112 generates a notification for directing the user to the shelf where the asset associated with pharmaceutical asset tracker 108A is located.

In some embodiments, the location information is used to determine whether an asset is at a location associated with an authorized distributor or retailer of the asset (e.g., a pharmacy, a hospital, a school, a church) (e.g., to detect fraud or unauthorized sale). In some embodiments, the location information is used to determine whether an asset has been mishandled (e.g., an asset requiring cold storage is determined to not be at a location with refrigeration). By advantageously using the location information, the determination of whether an asset has been mishandled may be useful to determine a root cause of a less effective group of assets. In some embodiments, the location information allows a distributor to better track an asset (e.g., without the disclosed system and methods, a distributor may not have visibility of the asset beyond a first point of sale (e.g., a local warehouse) and implementing a dedicated tracking system may not be feasible).

In particular embodiments, based on the location information, the server is configured to determine a location of the asset. For example, the server determines a location of the asset in an area based on the location information. The location information may be determined by the communications device based on a responsive crowdsourcing protocol or based on UWB transmission. For example, based on the responsive crowdsourcing protocol (e.g., using an application of the responsive crowdsourcing protocol) or the UWB transmission, the communications device determines a location of the asset relative to the communications device (e.g., direction and/or distance), and this determination is transmitted to the server. Based on the location of the asset relative to the communications device, the server determines the location of the asset (e.g., a specific aisle of a pharmacy, a specific shelf in a pharmacy).

For example, via crowdsourcing protocol 122A, the communications device 112 determines that the location of the asset associated with pharmaceutical asset tracker 108A is on the shelf. As another example, via crowdsourcing protocol 124A, the communications device 114 determines that the location of the asset associated with the pharmaceutical asset tracker 108A is on the shelf. As yet another example, via crowdsourcing protocol 122B, the communications device 112 determines that the location of the asset associated with pharmaceutical asset tracker 108B is away from the shelf at a specific location of the pharmacy. As yet another example, via crowdsourcing protocol 124B, the communications device 114 determines that the location of the asset associated with the pharmaceutical asset tracker 108B is away from the shelf at a specific location of the pharmacy.

In particular embodiments, the server is further configured to provide for display information regarding a group of pharmaceutical assets determined to be at a specified location. The group is identified based on pharmaceutical asset information for each of the assets in the group.

For example, the system 100 comprises electronic device 106, which may be a device for monitoring the asset. The server is configured to provide information for the electronic device 106 to display information regarding a group of pharmaceutical assets (e.g., a batch of the packets of medicine) determined to be at a specific location (e.g., a batch of the packets of medicine determined to be at a specific pharmacy location). The group of asset is identified based on pharmaceutical asset information transmitted from a respective pharmaceutical asset tracker associated with each of the assets in the group to a responsive communications device, and the responsive communications devices transmit the pharmaceutical asset information to the server. For example, the pharmaceutical asset information indicate that each of assets in the group is located at a same pharmacy location. In some embodiments, the server is further configured to provide mapping information (e.g., the received location information is integrated with mapping data) for integrating the display information on a map, for example, for a user of the electronic device 106 to view information regarding the group of asset visually on a map (e.g., inventory at different pharmacy locations on a map).

In some embodiments, the electronic device 106 is an electronic device of a physician writing a prescription for a patient. The system 100 may advantageously allow the physician to ensure that prescriptions are written to pharmacy locations with known inventory and that the patient will have access to the prescriptions. In some embodiments, based on the pharmaceutical asset information, a first pharmacy location is determined to have a higher inventory of a drug, compared to a second pharmacy location. In accordance with a determination that the first pharmacy location has a higher inventory of the drug than the second pharmacy location, the electronic device 106 transmits prescription information to the first pharmacy location. For example, the electronic device 106 determines the recipient of the prescription information based on the pharmaceutical asset information and drug inventories of the pharmacy locations. As another example, the electronic device 106 presents to a user (e.g., a physician) the drug inventories of the pharmacy locations, and based on the presented drug inventories, the user selects a recipient for the prescription information.

In some embodiments, the pharmaceutical asset tracker is configurable to be in a discoverable state. For example, when the pharmaceutical asset tracker is configured to be in the discoverable state, the tracker can transmit information (e.g., pharmaceutical asset information) that may be received by a compatible communications device via an associated crowdsourcing protocol, allowing the compatible communications device to detect the tracker. By configuring the tracker to be in the discoverable state, the disclosed systems and methods leverage the associated crowdsourcing protocol and the compatible communications device's ability to receive the information and transmits it for further processing, as disclosed herein. It should be appreciated that the term “discoverable state” is not meant to define a location of the pharmaceutical asset tracker. In contrast, if the pharmaceutical asset tracker is not configured to be in the discoverable state, the tracker may not transmit the information. A compatible communications device would not receive the information and would not detect the tracker. As a result, the information may not be transmitted for further processing and the advantages described herein may not be achieved.

The communications device is configured to search for a device in the discoverable state via the respective crowdsourcing protocol. For example, the pharmaceutical asset tracker is a tracker for locating a pharmaceutical asset, and the pharmaceutical asset tracker is configured to transmit data via one or more crowdsourcing protocols. The pharmaceutical asset tracker is set to be in the discoverable state, such that a communications device responsive to one of the one of more crowdsourcing protocols would find the discoverable pharmaceutical asset tracker. As a specific example, a communications device comprises an application associated with a crowdsourcing protocol. The communications device would find the discoverable pharmaceutical asset tracker (e.g., and an associated asset) via the crowdsourcing protocol.

In some embodiments, the pharmaceutical asset tracker is configured to transmit the pharmaceutical asset information to the communications device in accordance with a determination that the communications device is within the defined area (e.g., geo-fence 102). For example, the defined area is a geo-fence 102 around a boundary of a pharmacy. In accordance with a determination that a communications device (e.g., communications devices 112 and 114) is within the geo-fence 102 (e.g., a user of the communications device (e.g., communications device 112, 114, or 116) enters the pharmacy), the pharmaceutical asset tracker transmits the pharmaceutical asset information to the communications device via a responsive crowdsourcing protocol. In some embodiments, in accordance with a determination (e.g., by server 104, by a communications device) that a communications device is not within the geo-fence 102 (e.g., a user of the communications device (e.g., communications device 118) is not in the pharmacy), the communications device forgoes receiving the pharmaceutical asset information. In some embodiments, in accordance with a determination (e.g., by server 104, by a communications device) that a communications device is not within the geo-fence 102 (e.g., a user of the communications device (e.g., communications device 118) is not in the pharmacy), the pharmaceutical asset tracker forgoes transmitting the pharmaceutical asset information to the communications device.

In some embodiments, the pharmaceutical asset tracker is configured to cease transmitting the pharmaceutical asset information in accordance with a determination that the pharmaceutical asset tracker is no longer within the defined area. For example, the defined area is a geo-fence 102 around a boundary of a pharmacy. When a pharmaceutical asset tracker (e.g., pharmaceutical asset tracker 108C) is determined to be no longer within the defined area (e.g., a user leaves the pharmacy with the asset associated with the pharmaceutical asset tracker), the pharmaceutical asset tracker ceases transmitting the pharmaceutical asset information (e.g., set to inactive upon verification of purchase or transfer) (e.g., to protect patient privacy by not transmitting the pharmaceutical asset information to determine location information when the patient is home). In particular embodiments, because the pharmaceutical asset information is no longer being transmitted, the asset associated with the pharmaceutical asset tracker is determined (e.g., by server 104) to be removed from the inventory. In some embodiments, the server 104 is configured to cease processing the pharmaceutical asset information in accordance with a determination that the pharmaceutical asset tracker is no longer within the defined area.

In some embodiments, the pharmaceutical asset tracker is configured to cease transmitting the pharmaceutical asset information in accordance with a determination that the asset has been transferred. For example, the asset has been sold or moved to a different location (e.g., a different pharmacy). In accordance with a determination that the asset has been transferred (e.g., sold, moved to a different location), the pharmaceutical asset tracker ceases transmitting the pharmaceutical asset information. In some embodiments, in accordance with a determination that the asset has been transferred (e.g., sold, moved to a different location), the server ceases processing the pharmaceutical asset information. For example, user 110D purchased the asset associated with pharmaceutical asset tracker 108C, and in accordance with a determination that the asset associated with pharmaceutical asset tracker 108C has been purchased (e.g., an employee of the pharmacy removes or deactivate the pharmaceutical asset tracker (e.g., by tearing a specific portion of the pharmaceutical asset tracker), a barcode or a QR code on the asset has been scanned, and the server 104 is notified that the asset has been scanned), the pharmaceutical asset tracker 108C ceases transmitting pharmaceutical asset information and/or the server 104 ceases processing the pharmaceutical asset information. In particular embodiments, because the pharmaceutical asset information is no longer being transmitted, the asset associated with the pharmaceutical asset tracker is determined (e.g., by server 104) to be removed from the inventory.

In some embodiments, after a pharmaceutical asset has been purchased, a user who purchased the product may be associated to the asset (e.g., by the server 104). For example, after a pharmaceutical asset is purchased by user 110D, the user 110D may be associated to the product via an application downloaded by a user on communications device 118. The asset may be registered or activated with the application (e.g., scanning the product via the application). The server 104 would be notified (e.g., by the communications device 118 via the application) that the asset has been registered or activated. As a result, the user 110D may be notified about the asset (e.g., expiration, prescription refill reminders, directions, recalls) and/or may access information about the asset via the application. This association of the asset with the user may also be shared with the user's health-related applications. In some embodiments, after the product is associated with a user, the pharmaceutical asset information associated with the product may be updated to include patient ID, demographics, healthcare coverage, healthcare network, and relationship to pharmacy.

In some embodiments, if a pharmaceutical asset tracker is determined to cease transmitting and the last known location of the pharmaceutical asset tracker is within the defined area, then the pharmaceutical asset tracker and/or the asset is determined to be destroyed or tampered. In accordance with a determination that the pharmaceutical asset tracker and/or the asset is destroyed, the server may provide for generation of an alert indicating destruction or tampering of the asset.

In some embodiments, if a pharmaceutical asset tracker is determined to cease transmitting and the asset associated with the pharmaceutical asset tracker was not determined to be purchased or transferred, then the asset is determined to be stolen. In accordance with a determination that the asset is stolen, the server may provide for generation of an alert indicating theft of the asset.

In some embodiments, the pharmaceutical asset information comprises expiration information associated with the asset, the expiration information indicating a time the asset expires. For some examples, based on the pharmaceutical asset information, in accordance with a determination that the asset has expired or is about to expire, the server is configured to provide information for the electronic device 106 to indicate that the asset has expired or about to expire (e.g., to alert the pharmacy with the asset to remove the expired asset from inventory, to help a physician determine whether to prescribe a particular asset). Based on the expiration information, the electronic device 106 may determine a recommendation to a user (e.g., a physician, an asset manager) for prescribing or selling assets having an earlier upcoming expiration date or an expiration date within a desired date range, reducing a chance of assets expiring prior to prescription or sale.

In some embodiments, the server is configured to determine whether an inventory transfer criterion is met. In accordance with a determination that the inventory transfer criterion is met, the server is configured to provide for generation of an indication to transfer at least a portion of the group of assets from the first specified location to a second specified location. For example, the inventory transfer criterion indicates whether at least some of the group of assets need to be transfer to a different location.

As a specific example, the inventory transfer criterion indicates whether some of the packets of medication needs to be transfer to a second pharmacy. In accordance with a determination that the inventory transfer criterion is met, the server generates an indication to transfer at least some of the medication from the first pharmacy to the second pharmacy.

As an example, the inventory transfer criterion is met in accordance with a determination (e.g., by the server) that the second pharmacy has a demand for the medication (e.g., a quantity of asset is below a threshold quantity, a quantity of asset is below a threshold quantity and the second pharmacy is within a threshold distance of the first pharmacy), based on pharmaceutical asset information received from the second pharmacy. As another example, the inventory transfer criterion is met in accordance with a determination (e.g., by the server) that the first pharmacy has a surplus of the packets of medication (e.g., a quantity of asset is above a threshold quantity, a quantity of asset having a threshold expiration date or earlier is above a threshold quantity), based on the pharmaceutical asset information received from the first pharmacy.

In some embodiments, the server is configured to determine whether a quantity of the group of assets is below a threshold. In accordance with a determination that the quantity of the group of assets is below the threshold, the server is configured to provide for generation of an alert indicating low inventory. For example, the quantity of the group of assets (e.g., an inventory of packets of medicine in a pharmacy) is determined based on a number of assets that are found by one or more communications devices via one or more crowdsourcing protocols, as disclosed herein. In accordance with a determination (e.g., by the server) that the quantity of the group of assets is below a threshold, the server is configured to provide for generation of an alert indicating low inventory (e.g., to alert the pharmacy of higher-than-usual demand, to alert the pharmacy of impending low inventory, to alert the pharmacy to restock or request transfer from a second pharmacy with a surplus of the medicine).

In some embodiments, the server is configured to predict or forecast a demand of the asset in the specified location based on a quantity history of the group of assets (e.g., based on purchases (e.g., tracked as described herein), usage of asset (e.g., in-store use), destruction or loss of a pharmaceutical asset, based on dosages (e.g., infant vs. adult dosages) sold). In some embodiments, the demand is predicted using a model, and the model may be trained using pharmaceutical asset information received by the server (e.g., from the same pharmacy over time, from different pharmacies over time). The model may accurately predict demand of the asset based on how the inventory of the asset changes over time. Additional input, such as inputs related to geographical location, temperature, population, season, infection statistics, current events, and user inputs, may be used to predict the demand of the asset for the specific location. In some embodiments, the server is configured to predict the demand further based on the additional input. For example, the server to configured to receive a threshold number of inputs related to an increase in demand of the asset (e.g., a social media hashtag related to demand of the asset, a trending current event), and in response to receiving the threshold number of inputs related to the increase in demand, the server is configured to increase the predicted demand of the asset.

It is understood that the examples described herein are not meant to be limiting. For example, although an example of the asset is a packet of medicine, it is understood that the asset may comprise another object. For example, the asset may comprise a Cryotank. As another example, although an example of the defined area or the specific location is described with respect to a pharmacy, it is understood that the defined area or the specific location may be a different area or location (e.g., a different business, a warehouse, a resident, a public area).

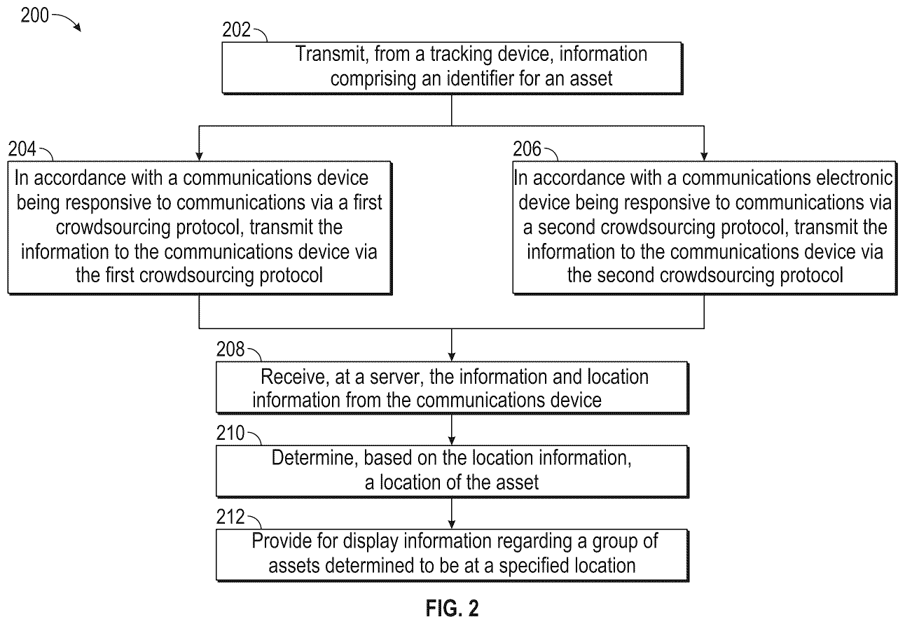

FIG. 2 illustrates an example method 200 for pharmaceutical asset tracking. The method may begin at step 202, a pharmaceutical asset tracker transmits pharmaceutical asset information to a communications device. For example, as described with respect to FIG. 1, pharmaceutical asset tracker 108A transmits pharmaceutical asset information to communications devices 112 and 114, and pharmaceutical asset tracker 108B transmits pharmaceutical asset information to communications device 112 and 114. In some embodiments, the pharmaceutical asset information comprises an identifier for a pharmaceutical asset associated with the pharmaceutical asset tracker in a defined area. For example, the pharmaceutical asset information comprises an identifier for a packet of medicine in a pharmacy. In some embodiments, the defined area has an area less than a transmission range of the pharmaceutical asset tracker.

At step 204, in accordance with the communications device being responsive to communications via a first crowdsourcing protocol, the pharmaceutical asset tracker transmits the pharmaceutical asset information to the communications device via the first crowdsourcing protocol. For example, as described with respect to FIG. 1, a communications device (e.g., communications device 112) is responsive to communications via a first crowdsourcing protocol. In accordance with the communications device being responsive to communications via the first crowdsourcing protocol (e.g., the communications device comprises a tracking application associated with the first crowdsourcing protocol), the pharmaceutical asset tracker (e.g., pharmaceutical asset tracker 108A, pharmaceutical asset tracker 108B) transmits the pharmaceutical asset information to the communications device via the first crowdsourcing protocol (e.g., crowdsourcing protocol 122A, crowdsourcing protocol 122B). In accordance with the communications device (e.g., communications device 114, communications device 116) not being responsive to communications via the first crowdsourcing protocol (e.g., the communications device does not comprise a tracking application associated with the first crowdsourcing protocol), the pharmaceutical asset tracker forgoes transmitting the pharmaceutical asset information to the communications device via the first crowdsourcing protocol.

As another example, a pharmaceutical asset tracker (e.g., pharmaceutical asset tracker 108A, pharmaceutical asset tracker 108B) transmits the pharmaceutical asset information via a first crowdsourcing protocol (e.g., crowdsourcing protocol 122A). A communications device (e.g., communications device 112) responsive to communications via the first crowdsourcing protocol (e.g., the communications device comprises a tracking application associated with the first crowdsourcing protocol) would receive the pharmaceutical asset information from the pharmaceutical asset tracker.

At step 206, in accordance with the communications device being responsive to communications via a second crowdsourcing protocol, the pharmaceutical asset tracker transmits the pharmaceutical asset information to the communications device via the second crowdsourcing protocol. For example, as described with respect to FIG. 1, a communications device (e.g., communications device 114) is responsive to communications via a second crowdsourcing protocol. In accordance with the communications device being responsive to communications via the second crowdsourcing protocol (e.g., the communications device comprises a tracking application associated with the second crowdsourcing protocol), the pharmaceutical asset tracker (e.g., pharmaceutical asset tracker 108A, pharmaceutical asset tracker 108B) transmits the pharmaceutical asset information to the communications device via the second crowdsourcing protocol (e.g., crowdsourcing protocol 124A, crowdsourcing protocol 124B). In accordance with the communications device (e.g., communications device 112, communications device 116) not being responsive to communications via the second crowdsourcing protocol (e.g., the communications device does not comprise a tracking application associated with the second crowdsourcing protocol), the pharmaceutical asset tracker forgoes transmitting the pharmaceutical asset information to the communications device via the second crowdsourcing protocol. For example, because the communications device 116 is neither responsive to the first nor the second crowdsourcing protocol, the pharmaceutical asset tracker does not transmit the pharmaceutical asset information to the communications device 116.

As another example, a pharmaceutical asset tracker (e.g., pharmaceutical asset tracker 108A, pharmaceutical asset tracker 108B) transmits the pharmaceutical asset information via a second crowdsourcing protocol (e.g., crowdsourcing protocol 122B). A communications device (e.g., communications device 112) responsive to communications via the second crowdsourcing protocol (e.g., the communications device comprises a tracking application associated with the second crowdsourcing protocol) would receive the pharmaceutical asset information from the pharmaceutical asset tracker.

At step 208, a server receives the pharmaceutical asset information and location information from the communications device. For example, as described with respect to FIG. 1, the server 104 receives pharmaceutical asset information and location information from communications devices 112 and 114. At step 210, a location of the asset is determined based on the location information. For example, as described with respect to FIG. 1, a location of the asset is determined based on the location information determined via a crowdsourcing protocol used for transmitting the pharmaceutical asset information or via UWB.

At step 212, the server provides for display information regarding a group of pharmaceutical assets determined to be at a specified location. In some embodiments, the group is identified based on pharmaceutical asset information for each of the assets in the group. For example, as described with respect to FIG. 1, the system 100 comprises electronic device 106, which may be a device for monitoring the asset. The server is configured to provide information for the electronic device 106 to display information regarding a group of pharmaceutical assets (e.g., a batch of the packets of medicine) determined to be at a specific location (e.g., a batch of the packets of medicine determined to be at a specific pharmacy location). The group of assets is identified based on pharmaceutical asset information transmitted from a respective pharmaceutical asset tracker associated with each of the assets in the group to a responsive communications device, and the responsive communications devices transmit the pharmaceutical asset information to the server. For example, the pharmaceutical asset information indicate that each of assets in the group is located at a same pharmacy location.

In some embodiments, the method 200 further comprises configuring the pharmaceutical asset tracker to be in a discoverable state. In some embodiments, the communications device is configured to search for a device in the discoverable state via the communications protocol used to transmit the pharmaceutical asset information to the communications device. For example, as described with respect to FIG. 1, the pharmaceutical asset tracker is a tracker for locating a pharmaceutical asset, and the pharmaceutical asset tracker is configured to transmit data via one or more crowdsourcing protocols. The pharmaceutical asset tracker is set to be in the discoverable state, such that a communications device responsive to one of the one of more crowdsourcing protocols would find the discoverable pharmaceutical asset tracker. As a specific example, a communications device comprises an application associated with a crowdsourcing protocol. The communications device would find the discoverable pharmaceutical asset tracker (e.g., and an associated asset) via the crowdsourcing protocol.

In some embodiments, the pharmaceutical asset tracker transmits the pharmaceutical asset information via BLE. For example, as described with respect to FIG. 1, in some embodiments, the pharmaceutical asset trackers 108A and 108B are configured to transmit the pharmaceutical asset information via BLE.

In some embodiments, the pharmaceutical asset tracker transmits the pharmaceutical asset information via UWB. For example, as described with respect to FIG. 1, in some embodiments, the pharmaceutical asset trackers 108A and 108B are configured to transmit the pharmaceutical asset information via UWB.

In some embodiments, the location information is based on the transmission of the pharmaceutical asset information via UWB. For example, as described with respect to FIG. 1, spatial and directional data provided by UWB may be used to locate the pharmaceutical asset tracker and a pharmaceutical asset associated with the pharmaceutical asset tracker.

In some embodiments, the identifier uniquely identifies the asset. For example, as described with respect to FIG. 1, the identifier comprises a code for uniquely identifying the packet of medicine (e.g., for individually tracking each packet of medicine). In some embodiments, the method 200 further comprises determining the location information based on the crowdsourcing protocol used to transmit the pharmaceutical asset information to the communications device. For example, as described with respect to FIG. 1, the pharmaceutical asset tracker is a tracker for locating a pharmaceutical asset, and the pharmaceutical asset tracker is configured to transmit data via one or more crowdsourcing protocols. Based on the crowdsourcing protocol used for transmission, a direction and/or distance of the pharmaceutical asset tracker (e.g., and the asset the pharmaceutical asset tracker is attached to) relative to the communications device receiving the pharmaceutical asset information may be determined (e.g., using an application associated the crowdsourcing protocol used for transmission).

In some embodiments, the pharmaceutical asset information is associated with product information of the asset. For example, as described with respect to FIG. 1, the product information comprises one or more of manufacturer information, product name, product type, date of manufacture (e.g., a time stamp), batch ID, quality inspection-related information, expiration date, serial number, lot ID, NDC number, category information, type information, dosage type (e.g., infant, adult), and storage requirement (e.g., cold storage, room temperature storage). In some embodiments, a server (e.g., server 104) is configured to store the product information, and the server is configured to retrieve the product information based on the received pharmaceutical asset information.

In some embodiments, the pharmaceutical asset tracker is attached to the asset. For example, as described with respect to FIG. 1, the pharmaceutical asset tracker is attached (e.g., using an adhesive) to a packaging of the asset (e.g., a packet of medicine). In particular embodiments, the asset is portable. For example, as described with respect to FIG. 1, the asset (e.g., a packet of medicine) may be picked up by a customer or an employee and transported to a different location (e.g., user 110C may pick up asset associated with pharmaceutical asset tracker 108B).

In some embodiments, the method 200 further comprises determining whether the communications device is within the defined area. In some embodiments, the pharmaceutical asset tracker transmits the pharmaceutical asset information to the communications device in accordance with a determination that the communications device is within the defined area.

For example, as described with respect to FIG. 1, the defined area is a geo-fence 102 around a boundary of a pharmacy. In accordance with a determination that a communications device (e.g., communications devices 112 and 114) is within the geo-fence 102 (e.g., a user of the communications device (e.g., communications device 112, 114, or 116) enters the pharmacy), the pharmaceutical asset tracker transmits the pharmaceutical asset information to the communications device via a responsive crowdsourcing protocol. In accordance with a determination that a communications device is not within the geo-fence 102 (e.g., a user of the communications device (e.g., communications device 118) is not in the pharmacy), the pharmaceutical asset tracker forgoes transmitting the pharmaceutical asset information to the communications device.

In some embodiments, the method 200 further comprises determining whether the pharmaceutical asset tracker is within the defined area. In accordance with a determination that the pharmaceutical asset tracker is no longer within the defined area, the pharmaceutical asset tracker ceases transmitting the pharmaceutical asset information. For example, as described with respect to FIG. 1, the defined area is a geo-fence 102 around a boundary of a pharmacy. When a pharmaceutical asset tracker (e.g., pharmaceutical asset tracker 108C) is determined to be no longer within the defined area (e.g., a user leaves the pharmacy with the asset associated with the pharmaceutical asset tracker), the pharmaceutical asset tracker ceases transmitting the pharmaceutical asset information (e.g., set to inactive upon verification of purchase or transfer). In particular embodiments, because the pharmaceutical asset information is no longer being transmitted, the asset associated with the pharmaceutical asset tracker is determined (e.g., by server 104) to be removed from the inventory.

In some embodiments, the method 200 further comprises determining whether the asset has been transferred. In accordance with a determination that the asset has been transferred, the pharmaceutical asset tracker ceases the pharmaceutical asset information. For example, as described with respect to FIG. 1, the asset has been sold or moved to a different location (e.g., a different pharmacy). In accordance with a determination that the asset has been transferred (e.g., sold, moved to a different location), the pharmaceutical asset tracker ceases transmitting the pharmaceutical asset information. In some embodiments, in accordance with a determination that the asset has been transferred (e.g., sold, moved to a different location), the server ceases processing the pharmaceutical asset information. For example, user 110D purchased the asset associated with pharmaceutical asset tracker 108C, and in accordance with a determination that the asset associated with pharmaceutical asset tracker 108C has been purchased (e.g., an employee of the pharmacy removes or deactivate the pharmaceutical asset tracker (e.g., by tearing a specific portion of the pharmaceutical asset tracker), a barcode or a QR code on the asset has been scanned, and the server 104 is notified that the asset has been scanned), the pharmaceutical asset tracker 108C ceases transmitting pharmaceutical asset information and/or the server 104 ceases processing the pharmaceutical asset information.

In some embodiments, the pharmaceutical asset information comprises expiration information associated with the asset, and the expiration information indicates a time the asset expires. For some examples, as described with respect to FIG. 1, based on the pharmaceutical asset information, in accordance with a determination that the asset has expired, the server is configured to provide information for the electronic device 106 to indicate that the asset has expired (e.g., to alert the pharmacy with the asset to remove the expired asset from inventory).

In some embodiments, the method 200 further comprises determining, by the server, whether an inventory transfer criterion is met. In accordance with a determination that the inventory transfer criterion is met, the server provides for generation of an indication to transfer at least a portion of the group of assets from the first specified location to a second specified location. For example, as described respect to FIG. 1, the inventory transfer criterion indicates whether some of the packets of medication needs to be transfer to a second pharmacy. In accordance with a determination that the inventory transfer criterion is met, the server generates an indication to transfer at least some of the medication from the first pharmacy to the second pharmacy. As another example, as described with respect to FIG. 1, the inventory transfer criterion is met in accordance with a determination (e.g., by the server) that the first pharmacy has a surplus of the packets of medication (e.g., a quantity of asset is above a threshold quantity, a quantity of asset having a threshold expiration date or earlier is above a threshold quantity), based on the pharmaceutical asset information received from the first pharmacy.

In some embodiments, the method 200 further comprises determining, by the server, whether a quantity of the group of assets is below a threshold. In accordance with a determination that the quantity of the group of assets is below the threshold, the server provides for generation of an alert indicating low inventory. For example, as described with respect to FIG. 1, the quantity of the group of assets (e.g., an inventory of packets of medicine in a pharmacy) is determined based on a number of assets that are found by one or more communications devices via one or more crowdsourcing protocols, as disclosed herein. In accordance with a determination (e.g., by the server) that the quantity of the group of assets is below a threshold, the server is configured to provide for generation of an alert indicating low inventory (e.g., to alert the pharmacy of higher-than-usual demand, to alert the pharmacy of impending low inventory, to alert the pharmacy to restock or request transfer from a second pharmacy with a surplus of the medicine).

In some embodiments, the method 200 further comprises predicting, by the server, a demand of the asset in the specified location based on a quantity history of the group of assets. For example, as described with respect to FIG. 1, the history may be based on purchases (e.g., tracked as described herein), usage of asset (e.g., in-store use), or destruction or loss of a pharmaceutical asset. In some embodiments, the demand is predicted using a model, and the model may be trained using pharmaceutical asset information received by the server (e.g., from the same pharmacy over time, from different pharmacies over time). The model may accurately predict demand of the asset based on how the inventory of the asset changes over time. Additional input, such as geographical location, temperature, population, season, and infection statistics, may be used to predict the demand of the asset for the specific location.

Additional examples of method 200 may be described with respect to FIG. 1. For brevity, some examples of method 200 are not described here.

Particular embodiments may repeat one or more steps of the method of FIG. 2, where appropriate. Although this disclosure describes and illustrates particular steps of the method of FIG. 2 as occurring in a particular order, this disclosure contemplates any suitable steps of the method of FIG. 2 occurring in any suitable order. Moreover, although this disclosure describes and illustrates an example method for method 200 including the particular steps of the method of FIG. 2, this disclosure contemplates any suitable method for method 200 including any suitable steps, which may include all, some, or none of the steps of the method of FIG. 2, where appropriate. Furthermore, although this disclosure describes and illustrates particular components, devices, or systems carrying out particular steps of the method of FIG. 2, this disclosure contemplates any suitable combination of any suitable components, devices, or systems carrying out any suitable steps of the method of FIG. 2.

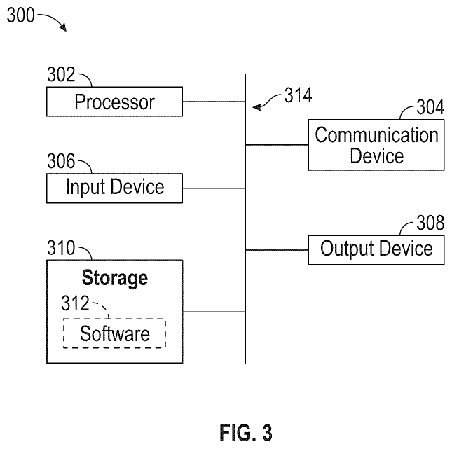

FIG. 3 illustrates an example electronic system 300. In particular embodiments, one or more electronic systems 300 perform one or more steps of one or more methods described or illustrated herein. In particular embodiments, one or more electronic systems 300 provide functionality described or illustrated herein. In particular embodiments, software running on one or more electronic systems 300 performs one or more steps of one or more methods described or illustrated herein or provides functionality described or illustrated herein. Particular embodiments include one or more portions of one or more electronic systems 300. Herein, reference to an electronic system may encompass a computer system or a computing device, and vice versa, where appropriate. Moreover, reference to an electronic system may encompass one or more electronic systems, where appropriate.

For example, pharmaceutical asset tracker 108A, 108B, or 108C comprises the system 300. As another example, communications device 112, 114, 116, or 118 comprises system 300. As another example, the server 104 comprises the system 300. As yet another example, electronic device 106 comprises the system 300.

This disclosure contemplates any suitable number of electronic systems 300. This disclosure contemplates electronic systems 300 taking any suitable physical form. System 300 can be a host computer connected to a network. System 300 can be a client computer or a server. System 300 can be any suitable type of microprocessor-based system, such as a dedicated computing device, a personal computer, work station, an embedded computer system, a system-on-chip (SoC), a single-board computer system (SBC) (e.g., a computer-on-module (COM), system-on-module (SOM)), an interactive kiosk, a mainframe, a mesh of computer systems, server, handheld computing device (portable electronic device) such as a phone or tablet, an edge-AI device, a neural network device, or a combination of two or more of these.

Where appropriate, electronic system 300 may include one or more electronic systems 300; be unitary or distributed; span multiple locations; span multiple machines; span multiple data centers; or reside in a cloud, which may include one or more cloud components in one or more networks. Where appropriate, one or more electronic systems 300 may perform without substantial spatial or temporal limitation one or more steps of one or more methods described or illustrated herein. As an example and not by way of limitation, one or more electronic systems 300 may perform in real time or in batch mode one or more steps of one or more methods described or illustrated herein. One or more electronic systems 300 may perform at different times or at different locations one or more steps of one or more methods described or illustrated herein, where appropriate.

The system 300 can include, for example, processor 302, input component 306, output component 308, storage 310, and/or communication component 304. The components of the system 300 may be coupled by a bus 314. Input component 306 and output component 308 can generally correspond to those described above and can either be connectable or integrated with the rest of the system.

It is understood that the illustration in FIG. 3 is not meant to limit the components that system 300 may comprise. The system 300 may include fewer components, more components, or other components (e.g., memory) than illustrated. System 300 can be a communication system configured to transmit information to and/or receive information from a second system. For example, the communication system can comprise a communication component 304, storage 310, and software 312.

In particular embodiments, processor 302 includes hardware for executing instructions, such as those making up a computer program. As an example and not by way of limitation, to execute instructions, processor 302 may retrieve (or fetch) the instructions from an internal register, an internal cache, memory (not shown), or storage 310; decode and execute them; and then write one or more results to an internal register, an internal cache, memory, or storage 310. In particular embodiments, processor 302 may include one or more internal caches for data, instructions, or addresses. This disclosure contemplates processor 302 including any suitable number of any suitable internal caches, where appropriate. As an example and not by way of limitation, processor 302 may include one or more instruction caches, one or more data caches, and one or more translation lookaside buffers (TLBs). Instructions in the instruction caches may be copies of instructions in memory or storage 310, and the instruction caches may speed up retrieval of those instructions by processor 302. Data in the data caches may be copies of data in memory or storage 310 for instructions executing at processor 302 to operate on; the results of previous instructions executed at processor 302 for access by subsequent instructions executing at processor 302 or for writing to memory or storage 310; or other suitable data. The data caches may speed up read or write operations by processor 302. The TLBs may speed up virtual-address translation for processor 302. In particular embodiments, processor 302 may include one or more internal registers for data, instructions, or addresses. This disclosure contemplates processor 302 including any suitable number of any suitable internal registers, where appropriate. Where appropriate, processor 302 may include one or more arithmetic logic units (ALUs); be a multi-core processor; or include one or more processors 302. Although this disclosure describes and illustrates a particular processor, this disclosure contemplates any suitable processor.

In particular embodiments, the memory includes main memory for storing instructions for processor 302 to execute or data for processor 302 to operate on. As an example and not by way of limitation, electronic system 300 may load instructions from storage 310 or another source (such as, for example, another electronic system 300) to the memory. Processor 302 may then load the instructions from the memory to an internal register or internal cache. To execute the instructions, processor 302 may retrieve the instructions from the internal register or internal cache and decode them. During or after execution of the instructions, processor 302 may write one or more results (which may be intermediate or final results) to the internal register or internal cache. Processor 302 may then write one or more of those results to the memory. In particular embodiments, processor 302 executes only instructions in one or more internal registers or internal caches or in the memory (as opposed to storage 310 or elsewhere) and operates only on data in one or more internal registers or internal caches or in the memory (as opposed to storage 310 or elsewhere). One or more memory buses (which may each include an address bus and a data bus) may couple processor 302 to the memory. Bus 314 may include one or more memory buses, as described below. In particular embodiments, one or more memory management units (MMUs) reside between processor 302 and the memory and facilitate accesses to the memory requested by processor 302. In particular embodiments, the memory includes random access memory (RAM). This RAM may be volatile memory, where appropriate. Where appropriate, this RAM may be dynamic RAM (DRAM), static RAM (SRAM), magneto-resistive RAM (MRAM), resistive RAM (RRAM), ferroelectric RAM (FRAM), flash memory, or phase-change memory (PCM). Moreover, where appropriate, this RAM may be single-ported or multi-ported RAM. This disclosure contemplates any suitable RAM. The memory may include one or more memories, where appropriate. Although this disclosure describes and illustrates particular memory, this disclosure contemplates any suitable memory.

In particular embodiments, storage 310 includes mass storage for data or instructions. As an example and not by way of limitation, storage 310 may include a hard disk drive (HDD), a floppy disk drive, flash memory, an optical disc, a magneto-optical disc, magnetic tape, or a Universal Serial Bus (USB) drive or a combination of two or more of these. Storage 310 may include removable or non-removable (or fixed) media, where appropriate. Storage 310 may be internal or external to electronic system 300, where appropriate. In particular embodiments, storage 310 is non-volatile, solid-state memory. In particular embodiments, storage 310 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 310 taking any suitable physical form. Storage 310 may include one or more storage control units facilitating communication between processor 302 and storage 310, where appropriate. Where appropriate, storage 310 may include one or more storages 310. Storage 310 may be a part of cloud storage. Although this disclosure describes and illustrates particular storage, this disclosure contemplates any suitable storage.

The input component 306 and/or the output component 308 may enable communication between a user and electronic system 300. Input component 306 can be any suitable component that provides input, such as a camera, touchscreen, keyboard or keypad, mouse, microphone, stylus, scanner, trackball, tablet, voice-recognition component, a sensor, or a combination of two or more of these. Output component 308 can be any suitable component that provides output, such as an illuminator, a touchscreen, haptics component, speaker, monitor, printer, or a combination of two or more of these.

An input/output (I/O) interface may be coupled to the input component 306 and/or the output component 308. In particular embodiments, the I/O interface includes hardware, software, or both, providing one or more interfaces for communication between electronic system 300 and one or more I/O components. This disclosure contemplates any suitable I/O components and any suitable I/O interfaces for them. Where appropriate, the I/O interface may include one or more components or software drivers enabling processor 302 to drive one or more of these I/O components. The I/O interface may include one or more I/O interfaces, where appropriate. Although this disclosure describes and illustrates a particular I/O interface, this disclosure contemplates any suitable I/O interface.

In particular embodiments, communication component 304 includes hardware, software, or both providing one or more interfaces for communication (such as, for example, packet-based communication) between electronic system 300 and one or more other electronic systems 300 or one or more networks. As an example and not by way of limitation, communication component 304 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication component 304 for it. As an example and not by way of limitation, electronic system 300 may communicate with an ad hoc network, a personal area network (PAN), a local area network (LAN), a wide area network (WAN), a metropolitan area network (MAN), or one or more portions of the Internet or a combination of two or more of disclosed network connections. One or more portions of one or more of these networks may be wired or wireless. As an example, electronic system 300 may communicate with a wireless PAN (WPAN) (such as, for example, a BLUETOOTH WPAN, Bluetooth Low Energy), a WI-FI network, a WI-MAX network, a cellular telephone network (such as, for example, a Global System for Mobile Communications (GSM) network), or other suitable wireless network or a combination of two or more of disclosed network connections. As another example, electronic system 300 may communicate via one or more crowdsourcing protocols, Near-Field communication (NFC), UWB, or a combination of two or more of disclosed network connections. Electronic system 300 may include any suitable communication component 304 for any of these networks, where appropriate. Communication component 304 may include one or more communication component 304, where appropriate. Although this disclosure describes and illustrates a particular communication interface, this disclosure contemplates any suitable communication interface.

In particular embodiments, bus 314 includes hardware, software, or both coupling components of electronic system 300 to each other. As an example and not by way of limitation, bus 314 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 314 may include one or more buses 314, where appropriate. Although this disclosure describes and illustrates a particular bus, this disclosure contemplates any suitable bus or interconnect.

Software 312, which can be stored in storage 310 or memory and executed by processor 302, can include, for example, the programming that embodies the functionality of the present disclosure (e.g., as embodied in the systems and methods described herein).

Software 312 can also be stored and/or transported within any non-transitory, computer-readable storage medium for use by or in connection with an instruction execution system, apparatus, or device, such as those described herein, that can fetch instructions associated with the software from the instruction execution system, apparatus, or device and execute the instructions.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Software 312 can also be propagated within any transport medium for use by or in connection with an instruction-execution system, apparatus, or device, such as those described above, that can fetch instructions associated with the software from the instruction-execution system, apparatus, or device and execute the instructions. In the context of this disclosure, a transport medium can be any medium that can communicate, propagate, or transport programming for use by or in connection with an instruction-execution system, apparatus, or device. The transport readable medium can include, but is not limited to, an electronic, magnetic, optical, electromagnetic, or infrared wired or wireless propagation medium.

System 300 can implement any operating system suitable for operating on the network. Software 312 can be written in any suitable programming language, such as C, C++, Java, or Python. In various embodiments, application software embodying the functionality of the present disclosure can be deployed in different configurations, such as in a client/server arrangement or through a Web browser as a Web-based application or Web service, for example.

In some embodiments, a pharmaceutical asset tracking system comprises: a pharmaceutical asset tracker configured to transmit pharmaceutical asset information to a communications device, wherein: the pharmaceutical asset information comprises an identifier for a pharmaceutical asset associated with the pharmaceutical asset tracker in a defined area, in accordance with the communications device being responsive to communications via a first crowdsourcing protocol, the pharmaceutical asset tracker transmits the pharmaceutical asset information to the communications device via the first crowdsourcing protocol, and in accordance with the communications device being responsive to communications via a second crowdsourcing protocol, the pharmaceutical asset tracker transmits the pharmaceutical asset information to the communications device via the second crowdsourcing protocol; and a server configured to: receive the pharmaceutical asset information and location information from the communications device; determine, based on the location information, a location of the asset; and provide for display information regarding a group of pharmaceutical assets determined to be at a specified location, wherein the group is identified based on pharmaceutical asset information for each of the assets in the group.

In some embodiments, the pharmaceutical asset tracker is configurable to be in a discoverable state, and the communications device is configured to search for a device in the discoverable state via the communications protocol used to transmit the pharmaceutical asset information to the communications device.

In some embodiments, the pharmaceutical asset tracker is configured to transmit the pharmaceutical asset information via Bluetooth Low Energy.

In some embodiments, the pharmaceutical asset tracker is configured to transmit the pharmaceutical asset information via ultra-wideband.

In some embodiments, wherein the location information is based on the transmission of the pharmaceutical asset information via ultra-wideband.

In some embodiments, the identifier uniquely identifies the asset, and the location information is determined based on the crowdsourcing protocol used to transmit the pharmaceutical asset information to the communications device.

In some embodiments, the pharmaceutical asset information is associated with product information of asset, and the server is configured to store the product information.

In some embodiments, the server is configured to retrieve the product information in response to receiving the pharmaceutical asset information.

In some embodiments, the pharmaceutical asset tracker is attached to the asset, and the asset is portable.

In some embodiments, the pharmaceutical asset tracker is configured to transmit the pharmaceutical asset information to the communications device in accordance with a determination that the communications device is within the defined area.

In some embodiments, the pharmaceutical asset tracker is configured to cease transmitting the pharmaceutical asset information in accordance with a determination that the pharmaceutical asset tracker is no longer within the defined area.

In some embodiments, the pharmaceutical asset tracker is configured to cease transmitting the pharmaceutical asset information in accordance with a determination that the asset has been transferred.

In some embodiments, the pharmaceutical asset information comprises expiration information associated with the asset, the expiration information indicating a time when the asset expires.

In some embodiments, the server is configured to: determine whether an inventory transfer criterion is met; and in accordance with a determination that the inventory transfer criterion is met, provide for generation of an indication to transfer at least a portion of the group of assets from the first specified location to a second specified location.

In some embodiments, the server is configured to: determine whether a quantity of the group of assets is below a threshold; and in accordance with a determination that the quantity of the group of assets is below the threshold, provide for generation of an alert indicating low inventory.

In some embodiments, the server is configured to predict a demand of the asset in the specified location based on a quantity history of the group of assets.

In some embodiments, the asset comprises the pharmaceutical asset tracker.

In some embodiments, a method for pharmaceutical asset tracking comprises: transmitting, from a pharmaceutical asset tracker, pharmaceutical asset information to a communications device, wherein: the pharmaceutical asset information comprises an identifier for a pharmaceutical asset associated with the pharmaceutical asset tracker in a defined area, in accordance with the communications device being responsive to communications via a first crowdsourcing protocol, the pharmaceutical asset tracker transmits the pharmaceutical asset information to the communications device via the first crowdsourcing protocol, and in accordance with the communications device being responsive to communications via a second crowdsourcing protocol, the pharmaceutical asset tracker transmits the pharmaceutical asset information to the communications device via the second crowdsourcing protocol.

In some embodiments, the pharmaceutical asset tracker is configured to be in a discoverable state, and the communications device is configured to search for a device in the discoverable state via the communications protocol used to transmit the pharmaceutical asset information to the communications device.

In some embodiments, the pharmaceutical asset tracker transmits the pharmaceutical asset information via Bluetooth Low Energy.

In some embodiments, the pharmaceutical asset tracker transmits the pharmaceutical asset information via ultra-wideband.

In some embodiments, location information of the pharmaceutical asset tracker is based on the transmission of the pharmaceutical asset information via ultra-wideband.

In some embodiments, the identifier uniquely identifies the asset, and location information of the pharmaceutical asset tracker is determined based on the crowdsourcing protocol used to transmit the pharmaceutical asset information to the communications device.

In some embodiments, the pharmaceutical asset information is associated with product information of the asset.

In some embodiments, the pharmaceutical asset tracker is attached to the asset, and the asset is portable.

In some embodiments, the pharmaceutical asset tracker transmits the pharmaceutical asset information to the communications device in accordance with a determination that the communications device is within the defined area.

In some embodiments, the method further comprises in accordance with a determination that the pharmaceutical asset tracker is no longer within the defined area, ceasing transmitting, by the pharmaceutical asset tracker, the pharmaceutical asset information.

In some embodiments, the method further comprises: determining whether the asset has been transferred; and in accordance with a determination that the asset has been transferred, ceasing transmitting, by the pharmaceutical asset tracker, the pharmaceutical asset information.

In some embodiments, the pharmaceutical asset information comprises expiration information associated with the asset, the expiration information indicating a time the asset expires.

In some embodiments, the asset comprises the pharmaceutical asset tracker.

In some embodiments, the pharmaceutical asset information is transmitted from the communications device to a server.

In some embodiments, a method for crowdsourced location-tracking comprises: receiving pharmaceutical asset information and location information from a communications device, wherein the pharmaceutical asset information is transmitted from a pharmaceutical asset tracker to the communications device via a crowdsourcing protocol; determining, based on the location information, a location of a pharmaceutical asset associated with the pharmaceutical asset tracker; and providing for display information regarding a group of pharmaceutical assets determined to be at a specified location, wherein the group is identified based on pharmaceutical asset information for each of the assets in the group.

In some embodiments, the method further comprises: in accordance with a determination that the pharmaceutical asset tracker is no longer within a defined area, ceasing processing the pharmaceutical asset information.

In some embodiments, the method further comprises: in accordance with a determination that the asset has been transferred, ceasing processing the pharmaceutical asset information.

In some embodiments, the method further comprises determining whether an inventory transfer criterion is met; and in accordance with a determination that the inventory transfer criterion is met, providing for generation of an indication to transfer at least a portion of the group of assets from the first specified location to a second specified location.

In some embodiments, the method further comprises: determining whether a quantity of the group of assets is below a threshold; and in accordance with a determination that the quantity of the group of assets is below the threshold, providing for generation of an alert indicating low inventory.

In some embodiments, the method further comprises predicting a demand of the asset in the specified location based on a quantity history of the group of assets.

In some embodiments, the pharmaceutical asset information is associated with product information of asset, and the method further comprises storing the product information.

In some embodiments, the method further comprises in response to receiving the pharmaceutical asset information, retrieving the product information.

In some embodiments, a non-transitory computer-readable medium stores one or more instructions, which, when executed by one or more processors of one or more electronic devices, cause the electronic devices to perform a method comprising: transmitting pharmaceutical asset information to a communications device, wherein: the pharmaceutical asset information comprises an identifier for a pharmaceutical asset associated with the pharmaceutical asset tracker in a defined area, in accordance with the communications device being responsive to communications via a first crowdsourcing protocol, the pharmaceutical asset information is transmitted to the communications device via the first crowdsourcing protocol, and in accordance with the communications device being responsive to communications via a second crowdsourcing protocol, the pharmaceutical asset information is transmitted to the communications device via the second crowdsourcing protocol; receiving the pharmaceutical asset information and location information from the communications device; determining, based on the location information, a location of the asset; and providing for display information regarding a group of pharmaceutical assets determined to be at a specified location, wherein the group is identified based on pharmaceutical asset information for each of the assets in the group.

In some embodiments, the method further comprises configuring a pharmaceutical asset tracker to be in a discoverable state, wherein the communications device is configured to search for a device in the discoverable state via the communications protocol used to transmit the pharmaceutical asset information to the communications device.

In some embodiments, the pharmaceutical asset information is transmitted via Bluetooth Low Energy.

In some embodiments, the pharmaceutical asset information is transmitted via ultra-wideband.

In some embodiments, the location information is based on the transmission of the pharmaceutical asset information via ultra-wideband.

In some embodiments, the identifier uniquely identifies the asset, and the method further comprises determining the location information based on the crowdsourcing protocol used to transmit the pharmaceutical asset information to the communications device.

In some embodiments, the pharmaceutical asset information is associated with product information of the asset.

In some embodiments, a pharmaceutical asset tracker is attached to the asset, and the asset is portable.

In some embodiments, the method further comprises determining whether the communications device is within the defined area, wherein the pharmaceutical asset information is transmitted to the communications device in accordance with a determination that the communications device is within the defined area.

In some embodiments, the method further comprises: determining whether a pharmaceutical asset tracker is within the defined area; and in accordance with a determination that the pharmaceutical asset tracker is no longer within the defined area, ceasing transmitting the pharmaceutical asset information.

In some embodiments, the method further comprises: determining whether the asset has been transferred; and in accordance with a determination that the asset has been transferred, ceasing transmitting the pharmaceutical asset information.

In some embodiments, the pharmaceutical asset information comprises expiration information associated with the asset, the expiration information indicating a time the asset expires.

In some embodiments, the method further comprises: determining whether an inventory transfer criterion is met; and in accordance with a determination that the inventory transfer criterion is met, providing for generation of an indication to transfer at least a portion of the group of assets from the first specified location to a second specified location.

In some embodiments, the method further comprises: determining whether a quantity of the group of assets is below a threshold; and in accordance with a determination that the quantity of the group of assets is below the threshold, providing for generation of an alert indicating low inventory.

In some embodiments, the method further comprises predicting a demand of the asset in the specified location based on a quantity history of the group of assets.

In some embodiments, the asset comprises a pharmaceutical asset tracker.

In some embodiments, a pharmaceutical asset tracking system, comprises: a pharmaceutical asset tracker configured to transmit pharmaceutical asset information to a communications device, wherein: the pharmaceutical asset information comprises an identifier for a pharmaceutical asset associated with the pharmaceutical asset tracker in a defined area, and the pharmaceutical asset tracker transmits the pharmaceutical asset information to the communications device via a crowdsourcing protocol; and a server configured to: receive the pharmaceutical asset information and location information from the communications device; determine, based on the location information, a location of the asset; and provide for display information regarding a group of pharmaceutical assets determined to be at a specified location, wherein the group is identified based on pharmaceutical asset information for each of the assets in the group.

In some embodiments, a method for pharmaceutical asset tracking, comprises: transmitting, from a pharmaceutical asset tracker, pharmaceutical asset information to a communications device, wherein: the pharmaceutical asset information comprises an identifier for a pharmaceutical asset associated with the pharmaceutical asset tracker in a defined area, the pharmaceutical asset tracker transmits the pharmaceutical asset information to the communications device via a crowdsourcing protocol, and a server is configured to: receive the pharmaceutical asset information and location information from the communications device; determine, based on the location information, a location of the asset; and provide for display information regarding a group of pharmaceutical assets determined to be at a specified location, wherein the group is identified based on pharmaceutical asset information for each of the assets in the group.

In some embodiments, a non-transitory computer-readable medium stores one or more instructions, which, when executed by one or more processors of one or more electronic devices, cause the electronic devices to perform a method comprising: transmitting pharmaceutical asset information to a communications device, wherein: the pharmaceutical asset information comprises an identifier for a pharmaceutical asset associated with the pharmaceutical asset tracker in a defined area, and the pharmaceutical asset tracker transmits the pharmaceutical asset information to the communications device via a crowdsourcing protocol; receiving the pharmaceutical asset information and location information from the communications device; determining, based on the location information, a location of the asset; and providing for display information regarding a group of pharmaceutical assets determined to be at a specified location, wherein the group is identified based on pharmaceutical asset information for each of the assets in the group.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

1. A pharmaceutical asset tracking system, comprising:
a pharmaceutical asset tracker configured to transmit pharmaceutical asset information to a communications device, wherein:
the pharmaceutical asset information comprises an identifier for a pharmaceutical asset associated with the pharmaceutical asset tracker in a defined area,
in accordance with the communications device being responsive to communications via a first crowdsourcing protocol, the pharmaceutical asset tracker transmits the pharmaceutical asset information to the communications device via the first crowdsourcing protocol, and
in accordance with the communications device being responsive to communications via a second crowdsourcing protocol, the pharmaceutical asset tracker transmits the pharmaceutical asset information to the communications device via the second crowdsourcing protocol; and
a server configured to:
receive the pharmaceutical asset information and location information from the communications device;
determine, based on the location information, a location of the asset; and
provide for display information regarding a group of pharmaceutical assets determined to be at a specified location, wherein the group is identified based on pharmaceutical asset information for each of the assets in the group.

2. The system of claim 1, wherein:
the pharmaceutical asset tracker is configurable to be in a discoverable state, and
the communications device is configured to search for a device in the discoverable state via the communications protocol used to transmit the pharmaceutical asset information to the communications device.

3. The system of claim 1, wherein:
the identifier uniquely identifies the asset, and
the location information is determined based on the crowdsourcing protocol used to transmit the pharmaceutical asset information to the communications device.

4. The system of claim 1, wherein the pharmaceutical asset tracker is configured to transmit the pharmaceutical asset information to the communications device in accordance with a determination that the communications device is within the defined area.

5. The system of claim 1, wherein the pharmaceutical asset tracker is configured to cease transmitting the pharmaceutical asset information in accordance with a determination that the pharmaceutical asset tracker is no longer within the defined area.

6. The system of claim 1, wherein the pharmaceutical asset tracker is configured to cease transmitting the pharmaceutical asset information in accordance with a determination that the asset has been transferred.

7. The system of claim 1, wherein the pharmaceutical asset information comprises expiration information associated with the asset, the expiration information indicating a time when the asset expires.

8. The system of claim 1, wherein the server is configured to:
determine whether an inventory transfer criterion is met; and
in accordance with a determination that the inventory transfer criterion is met, provide for generation of an indication to transfer at least a portion of the group of assets from the first specified location to a second specified location.

9. The system of claim 1, wherein the server is configured to:
determine whether a quantity of the group of assets is below a threshold; and
in accordance with a determination that the quantity of the group of assets is below the threshold, provide for generation of an alert indicating low inventory.

10. The system of claim 1, wherein the server is configured to predict a demand of the asset in the specified location based on a quantity history of the group of assets.

11. A method for pharmaceutical asset tracking, comprising:
transmitting, from a pharmaceutical asset tracker, pharmaceutical asset information to a communications device, wherein:
the pharmaceutical asset information comprises an identifier for a pharmaceutical asset associated with the pharmaceutical asset tracker in a defined area,
in accordance with the communications device being responsive to communications via a first crowdsourcing protocol, the pharmaceutical asset tracker transmits the pharmaceutical asset information to the communications device via the first crowdsourcing protocol, and
in accordance with the communications device being responsive to communications via a second crowdsourcing protocol, the pharmaceutical asset tracker transmits the pharmaceutical asset information to the communications device via the second crowdsourcing protocol.

12. The method of claim 11, wherein:
the pharmaceutical asset tracker is configured to be in a discoverable state, and
the communications device is configured to search for a device in the discoverable state via the communications protocol used to transmit the pharmaceutical asset information to the communications device.

13. The method of claim 11, wherein:
the identifier uniquely identifies the asset, and
location information of the pharmaceutical asset tracker is determined based on the crowdsourcing protocol used to transmit the pharmaceutical asset information to the communications device.

14. The method of claim 11, wherein the pharmaceutical asset tracker transmits the pharmaceutical asset information to the communications device in accordance with a determination that the communications device is within the defined area.

15. The method of claim 11, further comprising in accordance with a determination that the pharmaceutical asset tracker is no longer within the defined area, ceasing transmitting, by the pharmaceutical asset tracker, the pharmaceutical asset information.

16. The method of claim 11, further comprising:
determining whether the asset has been transferred; and
in accordance with a determination that the asset has been transferred, ceasing transmitting, by the pharmaceutical asset tracker, the pharmaceutical asset information.

17. The method of claim 11, wherein the pharmaceutical asset information comprises expiration information associated with the asset, the expiration information indicating a time the asset expires.

18. The method of claim 11, wherein the pharmaceutical asset information is transmitted from the communications device to a server.

19. A method for crowdsourced location-tracking, comprising:
receiving pharmaceutical asset information and location information from a communications device, wherein the pharmaceutical asset information is transmitted from a pharmaceutical asset tracker to the communications device via a crowdsourcing protocol;
determining, based on the location information, a location of a pharmaceutical asset associated with the pharmaceutical asset tracker; and
providing for display information regarding a group of pharmaceutical assets determined to be at a specified location, wherein the group is identified based on pharmaceutical asset information for each of the assets in the group.

20. The method of claim 19, further comprising:
in accordance with a determination that the pharmaceutical asset tracker is no longer within a defined area, ceasing processing the pharmaceutical asset information.

21. The method of claim 19, further comprising:
in accordance with a determination that the asset has been transferred, ceasing processing the pharmaceutical asset information.

22. The method of claim 19, further comprising:
determining whether an inventory transfer criterion is met; and
in accordance with a determination that the inventory transfer criterion is met, providing for generation of an indication to transfer at least a portion of the group of assets from the first specified location to a second specified location.

23. The method of claim 19, further comprising:
determining whether a quantity of the group of assets is below a threshold; and
in accordance with a determination that the quantity of the group of assets is below the threshold, providing for generation of an alert indicating low inventory.

24. The method of claim 19, further comprising predicting a demand of the asset in the specified location based on a quantity history of the group of assets.
